(19) United States
(12) Patent Application Publication
(10) Pub. No.: US 2003/0174070 A1
(43) Pub. Date: Sep. 18, 2003

(54) Wireless supervisory control and data acquisition

(76) Inventors: J. Kelly Garrod, Evergreen, CO (US); Timothy M. Sullivan, Littleton, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/389,341

(22) Filed: Mar. 13, 2003

Related U.S. Application Data
(60) Provisional application No. 60/364,297, filed on Mar. 13, 2002.

(51) Int. Cl. H04Q 9/00; G08C 19/22

(52) U.S. Cl. 340/870.07; 340/825.69; 340/825.72

(57) ABSTRACT

A remote monitoring and control device or “remote device” generally for use in SCADA type environments. The remote device comprises a wireless IP type communication facility. The remote device further comprises a variety of communication channels, links, or ports for transmitting commands and receiving data to and from various instruments that may be connected with the remote device. Using the wireless IP communication facility, the remote device may provide a conduit for information and commands between the instruments and a central computer. In addition, the remote device may monitor the instruments and provide an unsolicited communication with the central computer when an abnormal value is detected at an instrument.

### CROSS REFERENCE TO RELATED APPLICATIONS

This application is a non-provisional application claiming priority to provisional application No. 60/364,297 titled “Wireless Supervisory Control and Data Acquisition,” filed Mar. 13, 2002, the disclosure of which, including the appendix, is hereby incorporated by reference in its entirety.

### FIELD OF THE INVENTION

The present invention involves a wireless supervisory control and data acquisition system, method, and apparatus.

### BACKGROUND

Supervisory Control and Data Acquisition (“SCADA”) involves the centralized control and monitoring of instruments and other equipment at remote locations. For example, a SCADA system may be employed at a pumping station to monitor water level in tanks, pump operation, valve states, and the like, and convey the information regarding all of the equipment to a central computer. Moreover, the SCADA system may be configured so that commands may be issued from the central computer to activate or deactivate a pump, open or close a valve, and undertake any other actions at the remote location.

Conventional SCADA applications utilize a variety of technologies to retrieve data from remote locations. Oftentimes, conventional SCADA systems require customized development of sophisticated communication systems in order to review information from remote locations. Moreover, conventional SCADA systems typically require hard-wire connections between instruments at the remote locations and centrally located monitoring facilities.

The technical advancement of cellular-type communication infrastructure over the last several years has increased the options available to communicate with remote locations. One advancement in the analog cellular infrastructure is cellular digital packet data (“CDPD”), which provides a means of moving data within the cellular system. Similar technology has been developed for the digital wireless phone system. General packet radio service (“GPRS”) provides data communications on the digital wireless phone system in a manner similar to CDPD on the analog cellular system. Generally, wireless type communication technology is continually evolving.

### SUMMARY OF THE INVENTION

One aspect of the present invention involves a remote monitoring and control device adapted to employ wireless data communication technologies, such as the first generation cellular-based technology CDPD, the generation 2.5 (“G2.5”) technologies GPRS, code-division multiple access (“CDMA”) 1XRTT, and enhanced data GSM environment (“EDGE”), and the generation three (“G3”) technologies wideband CDMA (“WCDMA”) and CDMA 3XRTT, and the like, in a SCADA application. A remote device employing wireless data communication technologies provides a simple and reliable communications link without the need to develop a large private communications network as in conventional SCADA systems. Another aspect of the present invention involves the use of a connectionless protocol for wireless data transportation between a remote device and a central computer.

Another aspect of the invention involves the real-time monitoring of instruments at a remote location, and the notification of a central computer when a monitored instrument exceeds some threshold value. In this manner, the central computer or facility may be immediately notified when there is a potential problem at a remote location.

One aspect of the invention involves a remote monitoring device in communication with one or more instruments. The remote monitoring device comprises a central processing unit; at least one serial port in communication with the central processing unit, the at least one serial port for communicating with the one or more instruments to receive data from the one or more instruments; and a wireless modem in communication with the central processing unit, the wireless modem for transmitting the data from the remote monitoring device.

In one particular implementation, the at least one serial port is for communicating with the one or more instruments to transmit and receive data to and from the one or more instruments; and the wireless data modem is for transmitting and receiving the data to and from the remote monitoring device.

The remote monitoring device may further comprise at least one input port and at least one output port in communication with the central processing unit. The at least one input port may comprise a plurality of analog inputs and a plurality of digital inputs; and the at least one output port may comprise a plurality of digital outputs and a plurality of analog outputs.

The wireless modem may comprise a cellular digital packet data modem, a general packet radio service modem, a code-division multiple access modem, an enhanced data GSM environment modem, a wideband code-division multiple access modem, and generally a wireless data communication technology processor. The wireless modem may be configured to transmit and receive data packets using a connectionless protocol such as a user datagram protocol.

Another aspect of the invention involves a system for monitoring at least one instrument providing at least one data parameter. The system comprises a remote monitoring device including a wireless transceiver and at least one port in communication with the at least instrument, the at least one port receiving the data parameter from the instrument; a central computer in communication with the remote monitoring device; and wherein the remote monitoring device transmits a data packet associated with the at least one data parameter to the central computer using a connectionless protocol, such as a user datagram protocol.

Another aspect of the invention involves a method for transmitting information from a remote location to a central location in a SCADA environment. The method comprises the operations of: monitoring one or more data parameters at the remote location; determining if the one or more data parameters meets a value; if the one or more parameters meets the value, generating at least one data packet indicative of the one or more data parameters meeting the value; and wirelessly transmitting the at least one data packet to the central location.

The operation of wirelessly transmitting the at least one data packet to the central location further may comprise employing a cellular digital packet data communication processor to wirelessly transmit the at least one data packet to the central location, employing a general packet radio service communication processor to wirelessly transmit the at least one data packet to the central location, employing a code-division multiple access communication processor to wirelessly transmit the at least one data packet to the central location, employing an enhanced data GSM environment communication processor to wirelessly transmit the at least one data packet to the central location, employing a wideband code-division multiple access communication processor to wirelessly transmit the at least one data packet to the central location, and generally employing a wireless data communication technology to wirelessly transmit the at least one data packet to the central location.

The operation of wirelessly transmitting the at least one data packet to the central location may include using a connectionless protocol such as a user datagram protocol.

The method may further comprise the operation of receiving a polling request from a central computer. The polling request may be generated at the central location in response to the receipt of the at least one data packet. The at least one data packet may comprise an alarm data packet.

The method may further comprise the operations of: retrieving the one or more data parameters; and wirelessly transmitting at least one second data packet corresponding with the one or more data parameters to the central location.

### BRIEF DESCRIPTION OF THE DRAWINGS

The detailed description will refer to the following drawings, wherein like numerals refer to like elements, and wherein:

FIG. 1 is a system diagram illustrating a plurality of remote devices employed at various monitoring and control sites, the remote devices in wireless communication with a network, and further illustrating a central computer in communication with the network, in accordance with one embodiment of the invention;

FIG. 2 is a system diagram illustrating a remote device employed at a monitoring site to monitor and control, directly or via wireless signals from a central computer, a variety of instruments located at the monitoring site, in accordance with one embodiment of the present invention;

FIG. 3 is a block diagram of a remote device, in accordance with one embodiment of the present invention; and

FIG. 4 is a flowchart illustrating a method of monitoring one or more instruments, and generating at least one alarm if the one or more instruments goes out of range, in accordance with one embodiment of the present invention.

### DETAILED DESCRIPTION OF EMBODIMENTS OF THE INVENTION

Embodiments of the present invention involve a monitoring and control device with wireless communication capabilities (hereafter referred to as the “remote device”). The remote device is configured so that it may monitor, control, and generally provide a link through input and output channels to instruments that may be employed at any number of remotely located facilities. The remote device is further configured to wirelessly transmit and receive data, such as data packets, corresponding with the monitored instruments and to and from a central computer upon receipt of a request from the central computer. Furthermore, the remote device may be configured to monitor its inputs and generate and transmit information, such as an alarm data packet, to the central computer when the data received on an input channel indicates that some instrument in the remote facility is out of range.

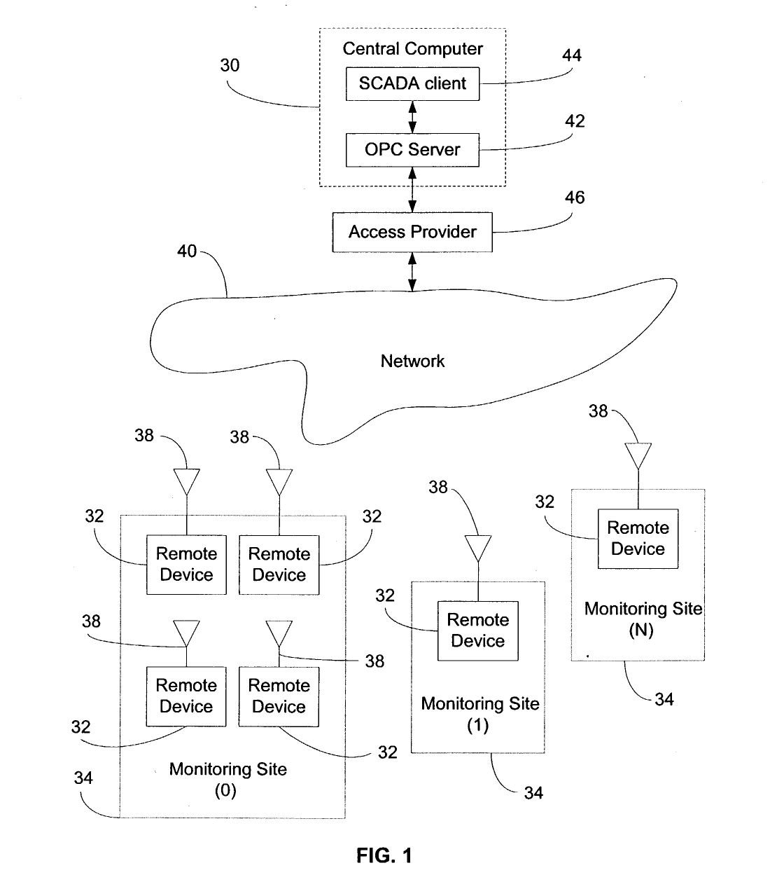

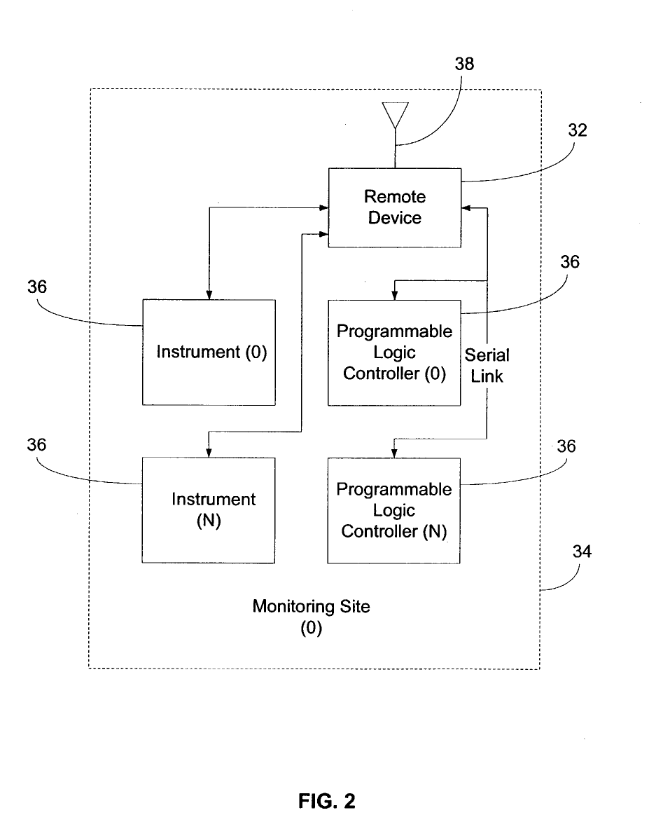

FIG. 1 is a system level diagram illustrating a central computer 30 adapted to communicate with one or more remote devices 32 employed at various remote locations 34, in accordance with one embodiment of the present invention. FIG. 2 is a second system level diagram illustrating one remote device 32 employed at a remote location 34 to monitor and/or control various instruments 36 at the remote location 34 in accordance with one embodiment of the present invention. As used herein, the term “remote instrument” or “instrument” will be used to refer to any type of instrument, sensor, measurement device, programmable logic controller (“PLC”), other remote device and the like, that may be employed at a monitoring location in a SCADA environment. As used herein, the phrases “monitoring site” or “monitoring locations” are used to refer to any location, facility, plant, treatment facility, processing facility, and the like where a system, method, or remote device conforming to the present invention may be employed to monitor and control instruments and equipment connected with the instruments.

The remote devices 32 are in wireless communication with a network 40, such as the Internet, a wide area network (“WAN”), a local area network (“LAN”), or the like, by way of a wireless transceiver or transceivers 38 operably connected with the remote device 32. One or more processing elements (hereafter the “central computer”) 30 that are located at or away from the monitoring site are also in communication with the network 40. A system in accordance with the present invention may be employed such that remote devices 32 are geographically proximate the central computer 30 (e.g., physically located in an oil refinery) or may be geographically remote from the central computer 30 (e.g., the central computer located at a facility in Texas and remote devices employed at oil fields in Colorado and Kuwait). Generally speaking, the remote device communicates wirelessly with the central computer. The remote device may, however, be located closely to the central computer or quite far from the central computer.

One example of a remote monitoring site 34 that may employ some or all aspects of the present invention is a water treatment facility. Typically, a water treatment facility has one or more storage tanks. One parameter that might be monitored by a remote device 32 is the water level or volume in each storage tank. The water level in the storage tanks can be used to determine water usage requirements for the region that the water treatment facility supplies water to. The volume within the tank provides key information for the plant operator to determine if the rate at which water is currently treated is consistent with usage throughout the system. For example, a high tank level indicates that more water is currently treated compared to usage. In contrast, a low tank level indicates that the usage is exceeding treatment, and that treatment should be increased to avoid the tank completely emptying. In typical operations, the water level in large water storage tanks does not exhibit dramatic fluctuations.

Another example of a remote monitoring site 34 is a water distribution infrastructure. The water distribution infrastructure typically includes pump stations, lift stations, pressure reducing stations and tanks, all of which have various parameters that require monitoring and have functions that require control. In one example, it is important to monitor lift stations since flooding may occur if the system is not operating properly. Additional examples can be found in the oil and gas industry to monitor and control well and pipeline instruments and equipment, and the electric utility industry to signal and control potential problems on the distribution grid.

In a SCADA system employing a remote device, in accordance with the present invention, the remote instruments are operably connected with devices, equipment, storage tanks, pumps, and any number of other types of equipment that may be found at a remote monitoring site. For instance, in the above example of a water treatment facility monitoring location, a plurality of capacitive proximity sensor type instruments may be connected with the liquid storage tanks in such a manner as to detect various liquid levels in the tanks. A remote device conforming to the invention is operably connected with the capacitive proximity sensor. In general terms, a capacitive proximity sensor reacts to the presence or approach of a target (e.g., water) by either providing a zero voltage at an output or by providing a voltage at an output. The remote device detects the voltage state of the proximity sensor and stores value in one or more registers of the remote device or generally in memory.

Generally, the remote device continuously or intermittently monitors the state of each instrument connected with the remote device. Further, the remote device stores in memory, such as one or more registers, at least the most recent information from the instruments. In response to a request or “poll” from the central computer, the remote device transmits a data packet corresponding with the information from the monitored instruments to the one or more central monitoring computers. In the example above regarding a connection of the remote device to capacitive proximity sensors, the remote device will transmit a data packet corresponding to the state of the sensors and hence the central computer can determine whether the tank is full, empty, or at some level therebetween. Besides transmitting data packets in response to a polling request from the central computer, the remote device may initiate the data packet transmission periodically, intermittently and/or in response to an unusual or alarm condition of the instrument or the mechanism that an instrument is connected with. In one particular implementation, the data packets from the remote device are wirelessly transmitted to the central computer using, in part, various wireless IP-type communication technologies, such as CDPD, GPRS, CDMA 1XRTT, EDGE, WCDMA, CDMA 3XRTT, and other wireless data communication technologies.

Referring to FIG. 1, in one particular implementation, the central computer 30 includes program code for executing a SCADA application package, such as those provided by Iconics™, Rockwell™, Intellution™, Wonderware™, and Wireless Systems™. In addition, the central computer 30 includes an OLE for Process Control™ (“OPC”) server 42 in communication with the SCADA application 44. It should be recognized that the SCADA application 44 and the server 42 may be run and/or implemented on the same or separate computing platforms. In one particular system implementation, the central computer 30 has a unique IP address and is in communication with an Internet access provider 46. The Internet access provider receives data packets, which have an internet protocol (“IP”) destination address appended to the data packets corresponding to the central computer address on the network, and routes the data packets to the central computer 30.

In one example, data packets are transported from the remote device 32 to the central computer based, in part, on the Modbus/TCP protocol as developed by Modicon/AEG Schneider Automation™. In contrast to the Modbus/TCP protocol, which uses the TCP/IP protocol, a remote device, system, or method of the present invention uses a connectionless protocol, such as the user datagram protocol (“UDP”). Since UDP is connectionless, the protocol avoids much of the overhead of the TCP connection establishment process. As used herein, the term “connectionless” is meant to refer to network protocols and communication techniques in which one device may communicate with another device without first establishing communication with the other device. Although not preferable, a remote device of the present invention may also be implemented with the TCP/IP protocol.

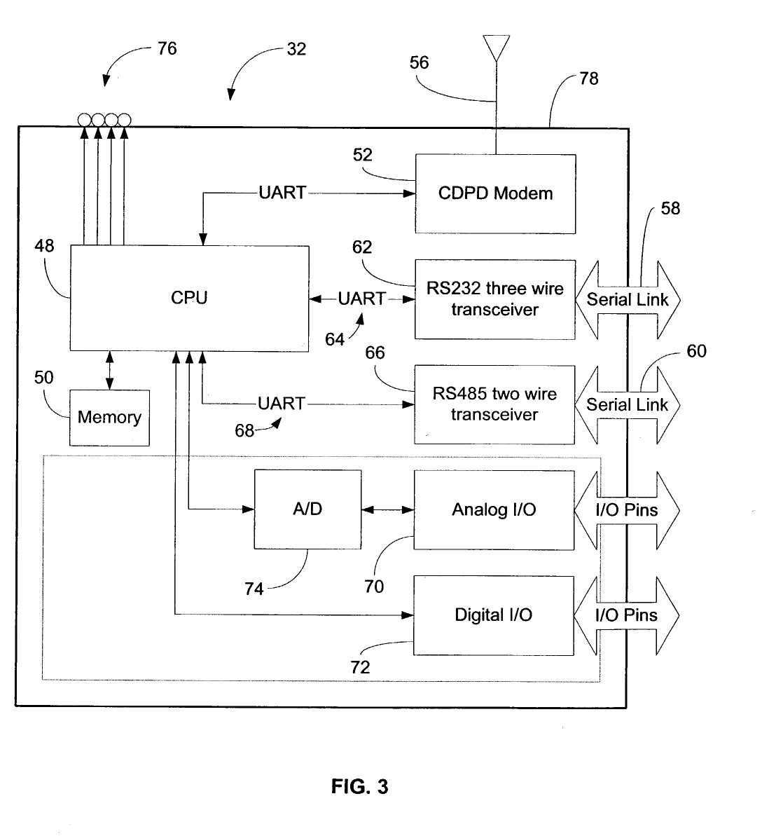

FIG. 3 is a block diagram of one implementation of a remote device 32 conforming to the present invention. As will be discussed below, the remote device 32 is in communication with one or more instruments 36 employed at a remote monitoring location 34. The remote device 32 optimizes the use of wireless data communication technologies to transmit and receive instrument data over a network 40 between the remote monitoring locations 34 and the central computer 30. As used herein, the phrase “wireless data communication technologies” is meant to refer to any data communication technology that may be employed to transmit data wirelessly, such as CDPD, GPRS, CDMA 1XRTT, EDGE, WCDMA, CDMA 3XRTT, and the like. The remote device 32 routes and manages data transmission between the instruments and the central computer 30. The remote device 32 of FIG. 3 is particularly adapted for CDPD-type wireless data transmission. However, the device may be configured similarly to support any wireless data communication technology. The remote device 32 may be configured to monitor instruments and then communicate with the central computer upon receipt of a request from the central computer 30. The remote device 32 may also be configured to monitor instruments and communicate with the central computer 30 without a request or poll from the central computer.

The remote device 32 includes an external connector (not shown) to attach to a power transformer and is configured to operate with an input voltage from 8 to 30 volts. Alternatively, especially when employed at monitoring locations that do not have a ready electrical power supply, the remote device can be powered by a remote power source, such as one or more batteries, a solar array, or the like. To provide a visual indication that the remote device is powered, the remote device includes a light emitting diode (“LED”) mounted externally on the housing that blinks when the remote device has power and is operating. In one example, the remote device is housed in a environmentally protected housing having a dimension of about 5.31″L×3.35″W×1.5″H.

The remote device 32 includes a central processing unit (“CPU”) 48, such as a Rabbit 2000™ processor. The CPU 48 is connected with or includes one or more memory units 50, such as a random access memory, read only memory, CD-ROM, or the like. In addition, the CPU 48 includes a brownout detector and a low voltage detector. In a remote device that communicates with the central computer using CDPD, a CDPD modem 52 is connected with the CPU 48. A first universal asynchronous receiver-transmitter (“UART”) 54 is connected between the CPU 48 and the CDPD modem 52 to manage asynchronous serial communication therebetween. In a remote device that communicates with the central computer using GPRS, a GPRS modem is connected with the CPU. In a remote device employing other wireless data communication technologies, the appropriate modem or communication processor is operably connected with the CPU. In one particular configuration, an external TNC type female connector (not shown) is connected to the CDPD modem. The TNC connector provides a connection point for an antena 56.

The remote device also includes a RS232 serial communications link 58 and a RS485 serial communication link 60 for interfacing with PLCs and other instruments. A RS232 three-wire transceiver 62 is connected with the CPU 48 to transmit and receive signals on the RS232 serial link 58. In one example, a second UART 64 manages asynchronous communications between the RS232 transceiver 62 and the CPU 48. An external RS232 DB9 connector (not shown) is attached to the housing and connected with the RS232 transceiver 62 to provide a connection point for an RS232 serial cable.

The remote device 32 further includes a RS485 two-wire transceiver 66 connected with the CPU 48 via a third UART 68 to manage asynchronous communications over the RS485 serial communication link 60. In one example, the RS485 transceiver 66 is configured as a two-wire interface with optional ground, and as a non-terminated master. The remote device 32 has user accessible external terminals to attach the physical RS485 wires and ground.

In addition to serial link channels, one particular embodiment of the remote device 32 may further include one or more analog and/or digital input, output or input/output (“I/O”) ports (70, 72). The I/O ports allow the remote device to interface with traditional SCADA instrumentation. In one particular example, the remote device 32 includes four analog input ports, four digital output ports, and eight digital input ports. The analog input ports are connected to a 12 bit analog-to-digital (A/D) converter 74. The A/D converter 74, the analog output ports, and the digital ports are each connected with the CPU 48. The four analog inputs are differential four-to-twenty milliamp analog inputs. Each analog input port is accurate to 0.1% of full scale, has an internal 250 ohm terminating resistor, and is calibrated and scaled using local menus.

The remote device 32 may include a menu program stored in memory for local set-up and configuration of the remote device. The menus provide a convenient way to set up, enable and configure various aspects of the remote device associated with serial link communication to instruments and the central computer, analog and digital port configurations, wireless communication parameters, and other features of the remote device. To configure the remote device, a user connects a RS232 serial cable to the DB9 connector. Once physically connected, the user can use any terminal program, such as HyperTerminal™, that is configured to 38400N81 to access the menus. Once the remote device is configured by way of the menus, the remote device configuration is stored in non-volatile memory.

In one particular implementation, the remote device 32 is configured to support Modicon™ MODBUS/RTU and MODBUS/ASCII protocols, which allow the remote device to interface directly over one of the serial links to PLCs and other instruments used to monitor and control equipment at a remote location. Besides the Modicon™ protocols, the remote device also supports “pass through” communication mode which allows raw data to be passed between a socket on the central computer 30 and an instrument via one of the serial links of the remote device. The pass through communication mode converts the remote device into a virtual serial link, allowing data and commands to pass directly between the central computer and one of the instruments connected with the remote device. It should be recognized that the particular implementations of a remote device to support the Modicon™ protocols and pass through communications are representative embodiments or examples of the present invention, and that other protocols and methodologies may be implemented in a remote device conforming to the present invention.

A summary of the state of each analog and digital I/O port (70, 72) is available by locally accessing the menus or remotely accessing the menus from the central computer. For example, whether a digital input port or output port is “on” or “off”, and the voltage at an analog input or output may be determined through the menu structure. Each digital output is user configured for sinking or sourcing, and is limited to 30 volts maximum and 500 milliamps maximum. The control and state of each digital output is available using the local menus and/or remotely using the central computer. The digital inputs may be optically isolated and may have an input threshold of 5 volts or greater. The state of each digital input is available using the local menus and/or remotely using the central computer.

The remote device 32 is configured in a master/slave arrangement such that the remote device routes messages between internal transceivers. Configured as such, a remote device may receive commands directly from the central computer 30 or may receive and route commands to an instrument connected with the remote device. Thus, the remote device is configured to discriminate between messages intended for it and messages intended for an instrument. Using the menus, the user sets the slave and master transceivers, baud rate, and remote protocol. The remote protocol or transmission mode (e.g., Modbus RTU or Modbus ASCII) is the protocol operating on the RS485 or RS232 interface. The remote device is typically configured as the master. Although in some instances, such as inter-remote device communications, one remote device may be a master and another remote device a slave. The remote device, in one example, supports serial link bauds rates of 9600N82, 9600E81, 9600O81, 19200N82, 19200E81, 19200O81, 38400N82, 38400E81, and 38400O81. The user also sets the Modbus/RTU address for the remote device.

The remote devices 32 communicate with the network 40 using a wireless data communication technology. In the case of the embodiment of the remote device of FIG. 3, various CDPD communication parameters may be configured using the menus accessible via the RS232 serial connection 58. In one example, the user may configure the source CDPD IP address of the remote device 32, the source port, the destination IP address, the destination port, and the cellular provider. The source IP address of the remote device is used to identify the remote device 32 in an IP network. Packets destined for the remote device 32 (e.g., packets transmitted from the central computer) will include the source IP address of the remote device in the header. In the case of CDPD, a cellular service provider will typically provide the unique IP address of the remote device 32. The source port and the destination port correspond to the port upon which messages are received from the central computer 30 and the port from which messages are transmitted from the remote device to the central computer 30, respectively. The destination IP address corresponds with the IP address of the central computer 30. Each data packet transmitted from the remote device will include the destination IP address in the header so that the packet may be properly routed to the central computer 30. A data packet may also include the source IP address of the remote device so that the central computer 30 can determine which remote device 32 transmitted the packets. The cellular provider field is used to configure the remote device to communicate with whatever cellular providers are operating a cellular network where the remote device is located.

To properly communicate with the central computer 30, the remote device 32 should be located in the communication range of a wireless network. For example, in a remote device employing a CDPD modem 52, the remote device should be located within the CDPD coverage area of a cellular network. In one particular configuration of the remote device, the CDPD communication rate is 19.2 baud, the transmission frequency is between 824.01 and 849.97 MHz, the reception frequency is between 869.01 and 894.97 MHz, sensitivity is −111 dBm, transmit power is between 600 mW and 3W, and the mode is full duplex.

One or more LEDs 76 may be provided on the housing 78 to provide visual indications corresponding with the function of the wireless communication signal between the remote device 32 and the wireless network that the remote device is within. In one example, the remote device includes a signal strength LED and a registered LED. The signal LED blinks to indicate the relative signal strength (“RSSI”) of the cellular signal. The LED blink rate corresponds to the signal strength. The registered LED illuminates to indicate that remote device has registered with the local cellular tower. If the remote device fails to register, the registered LED will blink a specified number of times followed by a pause to indicate the reason for the failure to register. In addition, the remote device includes an Alarm LED. Upon power up of the remote device 32, the Alarm LED stays illuminated until communications have been established with the online computer.

Referring again to FIG. 1, in a monitoring system according to one embodiment of the invention, the remote device 32 wirelessly communicates with the central computer 30. The central computer 30 includes a SCADA client 44 and an OPC server 42, for example. The OPC server 42, in one particular implementation, is a wireless OLE for Process Control (“WOPC”) server that provides communication between the remote device 32 and an OPC client, such as the SCADA client application 44 running on the central computer 30. The remote device 32 provides a communication link between the OPC server 42 and the instrumentation, PLCs, or other devices connected with the remote device. As such, communication to and from remote monitoring instruments 36 or controllers at a remote monitoring site 34 is facilitated by the remote device 32. Generally speaking, to obtain information from a remote device 32, the central computer 30 polls each remote wireless device in a separate thread to direct the remote device to transmit monitored parameters of the instruments to the central computer.

As discussed above, a remote device 32 wirelessly transmits data packets of information to the central computer 30 regarding the various instruments 36 that the remote device is connected with. The OPC server 42 receives the data packets, and translates information in the data packets into a standard format referred to as a “tag.” Each tag represents instrument information data, such as a sensor reading, an alarm state, or a status value. The SCADA application 44 portion of the central computer 30 is a client device, which communicates with the server 42, to access the tags and perform operations, such as process control tasks, based on the tag. In one embodiment, any OPC 2.0 compliant SCADA package can connect to the WOPC. The WOPC may be implemented using any generally available operating system such as the Windows™ operating systems, Windows NT, Windows 2000, and Windows XP.

To communicate with a remote device 32, the IP address (i.e., the source CDPD IP address) of the remote device is configured in the WOPC. In addition, the remote device 32 may be named to provide easy identification of the various remote devices connected with the central computer 30. For example, the name might represent the physical location of the remote device. After configuring the WOPC to recognize a particular remote device, the WOPC may further be configured to recognize a Modbus station of the remote device. The term “Modbus station” is used herein to refer to any instrument device, sensor, controller, and the like that may be or is connected with a remote device via the Modbus RTU or ASCII protocols.

To configure a Modbus station, first, the user selects a remote device configured within the WOPC. To associate a Modbus station with the remote device at the WOPC, the user configures: a station name, a station protocol, and a station address. The station name is typically used to easily identify a particular Modbus device, such as “Pump Station 1.” As discussed above, the protocol for the Modbus station is set as either ASCII or RTU. Typically, RTU is a more efficient and compact protocol and should be used with all devices that support it to minimize the network traffic. Some Modbus stations, however, may only support ASCII. In these cases the ASCII option will have to be used. The Modbus address, in one example, is selected from the values 1 to 247. Each Modbus station connected with the remote device has a unique address.

For each Modbus station, a retry value and a timeout value are set, in one example. The retry value is the number of times that the WOPC will attempt to send a message to the Modbus station before going into an error state. The timeout value is the length of time that the WOPC will wait for a response from a Modbus station before attempting a retry. Messages sent to and received from a Modbus station go through a remote device. In some instances, depending on such factors as the application and the cellular network response time, the response from a Modbus station may take several seconds. It is possible to take a station offline during periods of maintenance or no use. When a station is offline, the remote device does not have access to the station and it cannot be polled for data.

To obtain information from a Modbus station connected with a remote device, the OPC server transmits a polling request associated with the Modbus station to the remote device, and the remote device returns one or more data packets associated with the polling request. It should be recognized that a particular station may monitor numerous data parameters. To facilitate obtaining data from numerous stations, polling groups may be defined at the OPC server.

Polling groups are organized groupings of Modbus stations that will be read at a user defined polling interval. Each polling group can have a different polling interval. In one particular example, to define a polling group at the WOPC, each polling group is given a name. Next, the polling group is configured to poll or transmit requests to the remote devices on an interval (referred to as “interval polling”) or on a schedule (referred to as “schedule polling”). In interval polling, the server will transmit requests to or poll the remote device at a fixed interval. Interval polling involves a set time delay between polls of the device. After polling the remote device for some or all Modbus stations associated with the remote device and/or in a polling group, polling will be inactive for some specified period before polling the remote device again. In schedule polling, the server polls the remote device at a selected discrete time synchronized with the top of the hour.

A data tag represents a piece of information that the SCADA clients can access. Most data tags are associated with a Modbus item on a particular station. Some data tags such as the “In Service” tag provide state information about the station. The special state tags cannot be added or deleted by the user. The user can add or delete Modbus tags as needed. Each tag may be given a name and a description. The description of what the tag represents can be possible states of a device or maybe a description of a sensor measurement. There are no restrictions on description content. It is not used by the SCADA clients. The following table describes configurable tag parameters:

TABLE
CONFIGURABLE TAG PARAMETERS

| Configurable | |
|---|---|
| Tag Parameters | Description |
| Clamp Client | This check box configures the tag so |
| | that its value will never be outside the specified |
| Range: | range of Min and Max. This clamps the values of the |
| Min: | of the tag seen from the client SCADA systems. The |
| | absolute lowest value allowed for the tag. Any tag |
| Max: | value lower than this value will be adjusted up to the |
| | minimum. The absolute highest value allowed for |
| | the tag. Any value that is higher will be |
| | to chopped the max allowed highest value. |
| Noise DeadBand: | This field controls the OPC tag updates by ignoring tag |
| | value changes less than the percentage of full scale |
| | deifined by the min/max values. For example, |
| | if the min is 0 and the max is 100, full scale |
| | range is 100. If the value of the tag is 20 and the |
| | deadband is 5% then the tag value will not be updated |
| | unless the tag value goes above 25 or below 15. |
| Modbus Info: | |
| Register: | The Modbus register that will be associated with |
| | this tag. |
| Data Type: | The type of data. (Bit = Coil, Int 2 byte = 1 register, |
| | Int 4 byte = 2 registers, Float = 2 registers). |
| Write Enabled: | Flag indicates that this tag is a read/write tag. Write |
| | cannot be enabled for registers numbers |
| | that do not support write operations. |

Poll groups can be activated both from the SCADA client and from a user interface. If a SCADA client subscribes to data tags that are contained in a poll group, the poll group immediately begins to poll the device for updates based on its poll interval. If no clients are active, the poll group can be started using a graphical user interface (“GUI”) of the OPC Server. If a poll group is activated either by a client SCADA or by the GUI, the current tag values will be displayed as they are updated. The WOPC sever includes a status bar that indicates how many clients are using the poll group data.

Some OPC tags allow clients to write to them to change their values. For tags that represent device settings, changing the tag values will change the device setting. Other tags are generated by the OPC server such as an “In Service” tag or a “Force Update” tag. The SCADA systems can write to these tags and the GUI for the server also allows the user to write to the tags. To write to a tag, the tag is selected and the tag value is entered. The value is then communicated to the device. If the update is successful, the dialog will close. If the update fails, a message will be displayed.

The WOPC typically has two main windows, a toolbar, and a menu. The WOPC tool bar includes buttons for (1) new configuration, (2) save configuration, (3) delete, (4) poll all stations, (5) start polling, (6) stop polling, and (7) reset statistics. The WOPC menu includes (1) file, (2) edit, (3) view, (4) poll, and (5) help. The WOPC file menu includes (1) new, (2) save, (3) system parameters, and (4) exit. System parameter submenus allow the user to set-up a log file, default polling interval, default retry attempt, and an advanced button. The advanced window allows the user to change source and destination port number of the central computer. The WOPC edit menu includes (1) delete, and (2) properties. Several items in the main windows when highlighted contain property information.

The WOPC poll menu allows the user to activate poll groups or force a poll group to update. Polling involves the central computer sending a request to the remote device for information. For example, a remote device with a volume input from a water storage tank can be polled to retrieve the current volume of the tank and transmit a data packet corresponding with the volume to the central computer. The volume will then be displayed on the central computer.

The WOPC further includes, in one example, a remote device tree window. The remote device tree window is hierarchal. The top level of the remote device tree widow is the remote device, i.e., the MODBUS master. Two special OPC read only tags are available; message retry probability and average message time. The second level are stations each containing a unique address, i.e., Modbus slaves. In addition, the remote device itself can also assume a slave address. Two special OPC read/write tags are available: “in-service” (if true all poll groups shall update) and “force update” (write a 1 to tag and all tags shall update immediately). Both tags provide flexibility for SCADA software to control which remote devices are in service and to force tag updates on remote devices. The third level includes the poll groups. Four special OPC tags are available: corn status (indicates polling, waiting, simulation, error, or stopped), poll interval (allows SCADA software to directly control update interval), average poll time (average amount of time required to update all measurements), and force update (updates all tags in a poll group). The third level has the ability to contain one or more poll groups under the same station. In some instances, a poll group is capable of being polled only one time. This can be used to initialize constant data or data that could be updated using the force update tag.

One embodiment of a remote device, in accordance with the present invention, provides for exception polling, which allows the remote device to notify the central computer if any parameters falling outside of a normal range are received from an instrument at a monitoring site. Typically, polling of instruments, such as a Modbus station, is initiated from the OPC server. In exception polling, the remote device directly polls instruments and transmits a data packet to the central computer whenever the remote device identifies a value outside some range.

Since billing on the cellular system is based on the amount of data transmitted, it is important to minimize the amount of data transported. The majority of monitored parameters on a SCADA system are relatively constant. Thus, it is not necessary to continuously transmit this information to the central computer. Regular data collection periods are nonetheless important for data review and historical data collection.

If any data point falls outside of a normal range, however, it is important that such an event be quickly communicated to the central computer. Referring again to the example of water level monitoring of a tank in a water distribution system, a high or low tank level would be considered data falling outside the normal range. A high tank level may be an indication of a tank ready to overflow. A low tank level may be an indication of a pipeline break within the system. In either event, the operator needs to be informed immediately of the high or low tank condition.

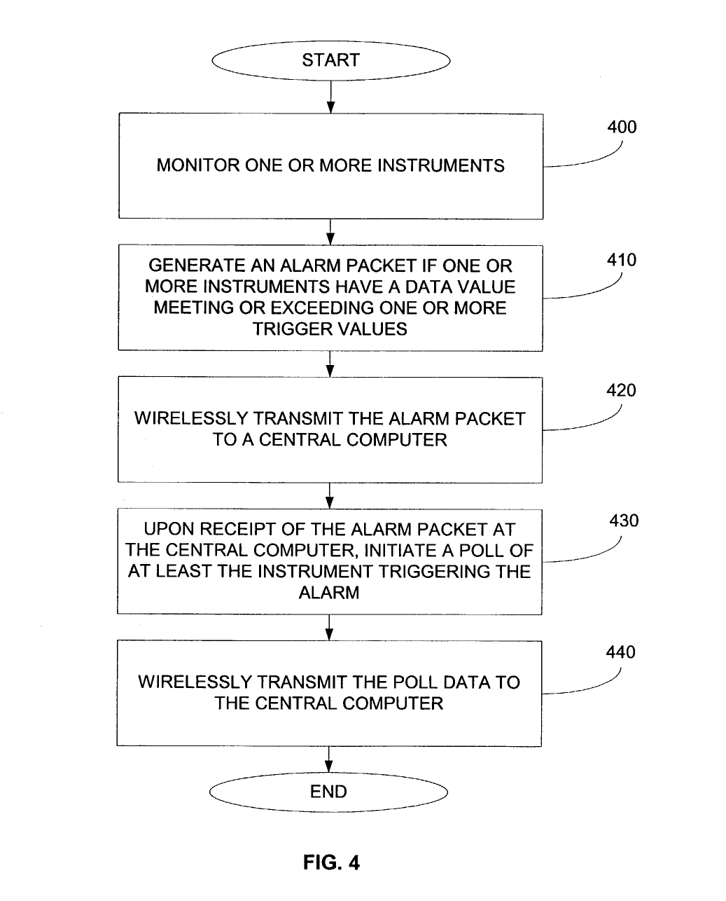

FIG. 4 illustrates one method, referred to herein as “exception polling,” for a remote device 32 to recognize a data value outside of a normal range and transmit one or more data packets contemporaneously of the recognition of a value outside the normal range, in accordance with the present invention. Exception polling provides the remote device 32 with the ability to recognize a value outside a normal range and immediately transmit an indication of such abnormal value to the central computer 30. For an exception poll, the remote device inspects data from instruments connected thereto on a regular basis to determine if the data is outside a preset limit (operation 400). The remote device is continuously, periodically, or intermittently monitoring the values from all instruments connected thereto and can determine when a value falls outside of its normal limits. In one example, the digital inputs of the remote device are individually configurable to generate and transmit an immediate unsolicited alarm packet to the central computer when a state change at the input occurs. When an exception occurs, i.e. the detection of data outside a limit, the remote device initiates an exception message (operation 410) and transmits an exception message to the central computer (operation 420).

Upon receipt of an alarm packet, the central computer will poll the remote device (operation 430). When the remote drive receives a poll from the central computer, it wirelessly transmits information regarding the alarm condition or exception in the form of a data packet to the central computer (operation 440).

The limits to trigger an alarm may be set at the central computer 30 or at the remote device 32. During normal operation, the central computer 30 initiates polls for data from the remote device 32. Specifically, the polling is originated from the WOPC at the central computer 30. This allows simple configuration of all remote devices 32 from a common point. In the event of an exception, the remote device 32 rather than the WOPC initiates a poll from the central computer 30 by transmitting an exception message to the central computer.

In one particular configuration, an exception message is in the form of an alarm packet that includes the IP address of the remote device from which the alarm packet was transmitted. The alarm packet is sent to the WOPC. In one implementation, the alarm packet does not include data related to the exception. Instead, upon receipt of an alarm packet, the WOPC polls the remote device. By polling the remote device, the WOPC retrieves data from the instrument 36, such as a Modbus device, connected with the remote device32 that caused the generation of the alarm packet. The central computer 30 may also be set to automatically poll a remote device 32 for all data associated with the remote device 32 whenever an alarm packet is received from the device.

If an alarm condition occurs, the remote device 32 attempts, one or more times, to transmit an alarm packet to the central computer 30. In one example, the remote device 32 makes four attempts at 15-second intervals to transmit the alarm packet. Upon receipt of an alarm packet, the central computer 30 sends an acknowledgement message to the remote device 32. The remote device 32 does not continue to transmit alarm packets after receipt of an acknowledgement message. The remote device 32, in another example, continues to transmit the alarm packet at a set interval, such as 15 seconds, until it receives the acknowledgment message from the central computer 30. When the alarm condition is triggered, the Alarm LED is illuminated and remains illuminated until the alarm is acknowledged by the central computer 30.

For instruments connected with one of the serial links (58, 60), the remote device 32 generates an alarm packet in response to an internal register value associated with an instrument 36. In one embodiment, the alarm packet includes the remote device IP address and the Modbus address of the particular instrument generating the alarm condition. Upon receipt of the alarm packet, the WOPC polls the remote device 32 for data from the particular instrument associated with the alarm condition.

Each input generally, and each analog input particularly may have a user settable alarm threshold and alarm reset value. The alarm threshold value defines the trigger value for an alarm. The reset value works in conjunction with the alarm threshold valve to help prevent false alarms. More particularly, if the reset value is less then the threshold value, the remote device 32 does not generate a second alarm until a measurement rises above the reset value and then falls below the threshold value. Also, if the reset value is greater than the alarm threshold value, the remote device 32 does not generate a second alarm until a measurement falls below the reset value and then returns above the threshold value. Reset occurs when the measurement passes the reset value. Threshold and reset value may be adjusted using the local menus and/or the central computer.

As discussed above, embodiments of the invention may employ the user datagram protocol or UDP transfer protocol in lieu of the transmission control protocol or TCP since UDP is a pier-to-pier and connectionless protocol. Because UDP does not provide means to determine whether a message was received by the intended central computing device, the central computer 30 sends an acknowledgement to the remote device 32. If a reply or acknowledgment is not received in some time interval, a timeout occurs and the remote device resends the data. The WOPC limits the number of sequential registers that can be read to 100. Since each register is a maximum of two bytes, this limits the UDP packets to less than the maximum packet limitation. One advantage of UDP as compare with TCP, is that the amount of data transmitted in a poll is substantially less using UDP compared to TCP. Since the data costs are based on the amount of data transmitted, the use of UDP provides a more cost effective solution.

Various embodiments of the invention are shown and described with a degree of particularity. Moreover, various operations in example methods of the present invention are shown and described in a particular order. It should be recognized, however, that various changes may be made to these embodiments, operations may be rearranged or eliminated, and other changes made be made without departing from the spirit and the scope of the present invention as defined in the following claims.

1. A remote monitoring device in communication with one or more instruments, the remote monitoring device comprising:
a central processing unit;
at least one serial port in communication with the central processing unit, the at least one serial port for communicating with the one or more instruments to receive data from the one or more instruments; and
a wireless modem in communication with the central processing unit, the wireless modem for transmitting the data from the remote monitoring device.

2. The remote monitoring device of claim 1 wherein:
the at least one serial port for communicating with the one or more instruments to transmit and receive data to and from the one or more instruments; and
the wireless data modem for transmitting and receiving the data to and from the remote monitoring device.

3. The remote monitoring device of claim 1 further comprising:
at least one input port and at least one output port in communication with the central processing unit.

4. The remote monitoring device of claim 3 wherein
the at least one input port comprises a plurality of analog inputs and a plurality of digital inputs; and
the at least one output port comprises a plurality of digital outputs and a plurality of analog outputs.

5. The remote monitoring device of claim 1 wherein the at least one serial port further comprises a RS485 two wire transceiver.

6. The remote monitoring device of claim 1 wherein the at least one serial port further comprises a RS232 three wire transceiver.

7. The remote monitoring device of claim 1 wherein the wireless modem comprises a cellular digital packet data modem.

8. The remote monitoring device of claim 1 wherein the wireless modem is configured to transmit and receive data packets using a connectionless protocol.

9. The remote monitoring device of claim 8 wherein the connectionless protocol is a user datagram protocol.

10. The remote monitoring device of claim 1 wherein the wireless modem includes a general packet radio service modem.

11. The remote monitoring device of claim 1 wherein the wireless modem includes a code-division multiple access modem.

12. The remote monitoring device of claim 1 wherein the wireless modem includes an enhanced data GSM environment modem.

13. The remote monitoring device of claim 1 wherein the wireless modem includes a wideband code-division multiple access modem.

14. The remote monitoring device of claim 1 wherein the wireless modem includes a wireless data communication technology processor.

15. A system for monitoring at least one instrument providing at least one data parameter, the system comprising:
a remote monitoring device including a wireless transceiver and at least one port in communication with the at least instrument, the at least one port receiving the data parameter from the instrument;
a central computer in communication with the remote monitoring device; and
wherein the remote monitoring device transmits a data packet associated with the at least one data parameter to the central computer using a connectionless protocol.

16. The system of claim 7 wherein the connectionless protocol comprises a user datagram protocol.

17. A method for transmitting information from a remote location to a central location in a SCADA environment, the method comprising:
monitoring one or more data parameters at the remote location;
determining if the one or more data parameters meets a value;
if the one or more parameters meets the value, generating at least one data packet indicative of the one or more data parameters meeting the value; and
wirelessly transmitting the at least one data packet to the central location.

18. The method of claim 17 wherein the operation of wirelessly transmitting the at least one data packet to the central location further comprises employing a cellular digital packet data communication processor to wirelessly transmit the at least one data packet to the central location.

19. The method of claim 17 wherein the operation of wirelessly transmitting the at least one data packet to the central location further comprises employing a general packet radio service communication processor to wirelessly transmit the at least one data packet to the central location.

20. The method of claim 17 wherein the operation of wirelessly transmitting the at least one data packet to the central location further comprises employing a code-division multiple access communication processor to wirelessly transmit the at least one data packet to the central location.

21. The method of claim 17 wherein the operation of wirelessly transmitting the at least one data packet to the central location further comprises employing an enhanced data GSM environment communication processor to wirelessly transmit the at least one data packet to the central location.

22. The method of claim 17 wherein the operation of wirelessly transmitting the at least one data packet to the central location further comprises employing a wideband code-division multiple access communication processor to wirelessly transmit the at least one data packet to the central location.

23. The method of claim 17 wherein the operation of wirelessly transmitting the at least one data packet to the central location further comprises employing a wireless data communication technology to wirelessly transmit the at least one data packet to the central location.

24. The method of claim 17 wherein the operation of wirelessly transmitting the at least one data packet to the central location includes using a connectionless protocol.

25. The method of claim 24 wherein the connectionless protocol includes a user datagram protocol.

26. The method of claim 17 further comprising the operation of receiving a polling request from a central computer.

27. The method of claim 26 wherein the polling request is generated at the central location in response to the receipt of the at least one data packet.

28. The method of claim 26 further comprising the operation of
retrieving the one or more data parameters; and
wirelessly transmitting at least one second data packet corresponding with the one or more data parameters to the central location.
